(19) United States
(12) Patent Application Publication
(10) Pub. No.: US 2023/0288714 A1
(43) Pub. Date: Sep. 14, 2023

(54) DEVICE FOR GENERATING A DEFINED LASER ILLUMINATION ON A WORK PLANE

(71) Applicant: TRUMPF Laser- und Systemtechnik GmbH, Ditzingen (DE)

(72) Inventors: Christoph Tillkorn, Villingendorf (DE); Andreas Heimes, Renningen (DE)

(21) Appl. No.: 18/318,753

(22) Filed: May 17, 2023

Related U.S. Application Data
(63) Continuation of application No. PCT/EP2021/079020, filed on Oct. 20, 2021.

(30) Foreign Application Priority Data
Nov. 19, 2020 (DE) 10 2020 130 651.2

(51) Int. Cl. G02B 27/09; G02B 17/00; G02B 17/08

(52) U.S. Cl. CPC G02B 27/0988; G02B 27/0961; G02B 27/0927; G02B 17/004; G02B 17/0832; G02B 13/16

(57) ABSTRACT

A device includes a laser light source configured to generate a raw laser beam, and an optical arrangement configured to shape the raw laser beam into an illumination beam. The optical arrangement includes a beam transformer with an exit aperture, a first group of optical elements and a second group of optical elements for beam shaping. The beam transformer is configured to expand the raw laser beam in the direction of a long axis. The first group of optical elements comprises a homogenizer configured to homogenize the expanded raw laser beam. The second group of optical elements comprises at least one lens configured to image the exit aperture of the beam transformer. The first group of optical elements generates an intermediate image. The device further includes an imaging optical unit configured to image the intermediate image into the work plane.

### CROSS REFERENCE TO RELATED APPLICATIONS

This application is a continuation of International Application No. PCT/EP2021/079020 (WO 2022/106138 A1), filed on Oct. 20, 2021, and claims benefit to German Patent Application No. DE 10 2020 130 651.2, filed on Nov. 19, 2020. The aforementioned applications are hereby incorporated by reference herein.

### FIELD

Embodiments of the present invention relate to a device for generating a defined laser illumination on a work plane.

### BACKGROUND

A device for generating a defined laser illumination on a work plane is described, for example, in WO 2018/019374 A1.

The line-shaped laser illumination from such a device can in particular be used to machine a workpiece. By way of example, the workpiece can be a plastics material on a glass plate serving as a carrier material. In particular, the plastics material can be a film on which organic light-emitting diodes, which are known as OLEDs, and/or thin-film transistors are produced. OLED films find increased use for displays in smartphones, tablet PCs, television sets and other equipment with a screen display. The film must be detached from the glass carrier after the electronic structures have been produced. Advantageously, this can be implemented using a laser illumination in the form of a thin laser line, which is moved at a defined speed relative to the glass plate and in the process breaks the adhesive connection of the film through the glass plate. In practice, such an application is frequently referred to as LLO or laser lift off.

Another application for the illumination of a workpiece with a defined laser line can be the line-by-line melting of amorphous silicon on a carrier plate. In this case, the laser line is likewise moved at a defined speed relative to the workpiece surface. As a result of the melting, the comparatively cheap amorphous silicon can be converted into higher-grade polycrystalline silicon. In practice, such an application is frequently referred to as solid state laser annealing or SLA.

On the work plane, such applications require a laser line which is as long as possible in one direction, in order to capture a work area that is as wide as possible, and which is very short in the other direction by comparison thereto, in order to provide an energy density required for the respective process. Accordingly, a long, thin laser line is desirable, with a large aspect ratio of for example 10 μm line width over a length of 100 mm parallel to the work plane. The direction in which the laser line extends is usually referred to as the long axis and the line width is referred to as the short axis of what is known as the beam profile. As a rule, the laser line should have a defined intensity profile along both axes. For example, it is desirable for the laser line to have an intensity profile that is as rectangular or trapezoidal as possible along the long axis, said trapezoidal intensity profile possibly being advantageous if a plurality of such laser lines are intended to be placed next to one another in order to form a longer overall line. Depending on the application, a rectangular intensity profile (what is known as a top hat profile), a Gaussian profile or any other intensity profile is desired along the short axis.

WO 2018/019374 A1 cited at the outset discloses a device of the type set forth at the outset and including numerous details relating to the elements of the optical arrangement. The optical arrangement contains a collimator which collimates the raw laser beam, and a beam transformer, a homogenizer and a focusing stage. The beam transformer receives the collimated raw beam and expands the latter in the direction of the long axis. In principle, the beam transformer may also receive a plurality of raw laser beams from a plurality of laser sources and combine said raw laser beams in order to form an expanded laser beam with a higher power. The homogenizer generates the desired beam profile in the direction of the long axis. The focusing stage focuses the reshaped laser beam onto the defined position in the region of the work plane. The known device is suitable for LLO and SLA applications. However, it is suboptimal for a few specific LLO applications, for instance when detaching what are known as μLEDs. For such a case, it would be desirable to provide a multiplicity of separate top hat-shaped intensity profiles. By way of example, an arrangement in which a multiplicity of separate top hat-shaped intensity profiles are arranged equidistantly along a line may be desirable. This is not offered by the device from WO 2018/019374 A1.

### SUMMARY

Embodiments of the present invention provide a device for generating a defined laser illumination on a work plane. The device includes a laser light source configured to generate a raw laser beam, and an optical arrangement configured to receive the raw laser beam and shape the raw laser beam along an optical axis into an illumination beam. the illumination beam defines a beam direction that intersects the work plane. The illumination beam, in a region of the work plane, has a beam profile with a long axis beam width along a long axis and a short axis beam width along a short axis. Both the long axis and the short axis are perpendicular to the beam direction. The optical arrangement includes a beam transformer with an exit aperture, a first group of optical elements for beam shaping in the direction of the long axis, and a second group of optical elements for beam shaping in the direction of the short axis. The beam transformer is configured to expand the raw laser beam in the direction of the long axis in order to generate an expanded raw laser beam. The first group of optical elements includes a homogenizer configured to homogenize the expanded raw laser beam in the direction of the long axis. The second group of optical elements includes at least one lens configured to image the exit aperture of the beam transformer into the work plane. The first group of optical elements generates an intermediate image downstream of the homogenizer. The device further includes an imaging optical unit configured to image the intermediate image into the work plane.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a simplified and schematic illustration of the long axis beam path of a device according to an embodiment;

FIG. 1b shows a simplified and schematic illustration of the short axis beam path of the device from FIG. 1a according to an embodiment;

FIG. 2 shows a simplified illustration of the beam profile according an embodiment;

FIG. 3 shows a plan view of an advantageous beam profile according to an embodiment;

FIG. 4 shows the long axis beam path and the short axis beam path from FIGS. 1a and 1b with further details according to an embodiment;

FIGS. 5a-c show exemplary intensity profiles according to an embodiment;

FIG. 6 shows details of a device with mirror folding in the long axis beam path according to an embodiment, and

FIG. 7 shows a schematic illustration of the mirror folding from FIG. 6 according to an embodiment.

### DETAILED DESCRIPTION

Embodiments of the present invention provide a device for generating a defined laser illumination on a work plane, having a laser light source configured to generate a raw laser beam and having an optical arrangement which receives the raw laser beam and shapes the latter along an optical axis into an illumination beam, the illumination beam defining a beam direction which intersects the work plane and the illumination beam, in the region of the work plane, having a beam profile with a long axis with a long axis beam width and with a short axis with a short axis beam width, both perpendicular to the beam direction, the optical arrangement containing a beam transformer with an exit aperture, a first group of optical elements for beam shaping in the direction of the long axis and a second group of optical elements for beam shaping in the direction of the short axis, the beam transformer expanding the raw laser beam in the direction of the long axis in order to generate an expanded raw laser beam, the first group of optical elements containing a homogenizer which homogenizes the expanded raw laser beam in the direction of the long axis, and the second group of optical elements containing at least one lens which images the exit aperture of the beam transformer into the work plane.

A device of the type set forth at the outset, by means of which it is possible to generate a defined laser line with a large aspect ratio cost-effectively. The device of the type set forth at the outset can cost-effectively and flexibly allow a multiplicity of different illumination patterns on a work plane.

According to one aspect of the present invention, a first group of optical elements generates an intermediate image downstream of the homogenizer and further implements an imaging optical unit which images the intermediate image into the work plane.

The optical elements of the first group have an optical refractive power predominantly in the direction of the long axis. Consequently, they predominantly influence the beam profile in the direction of the long axis. In contrast thereto, the optical elements of the second group have an optical refractive power predominantly in the direction of the short axis. Consequently, they predominantly influence the beam profile in the direction of the short axis. In exemplary embodiments, the optical elements may each contain cylindrical elements, in particular cylindrical lenses and/or cylindrical mirrors, which are each arranged so that they develop an optical refractive power either in the direction of the long axis or in the direction of the short axis. Therefore, the beam shaping in the direction of the long axis and the beam shaping in the direction of the short axis is divided into two in the preferred exemplary embodiments so that the beam shaping in the direction of the long axis and the beam shaping in the direction of the short axis can each be considered separately. This makes it possible to dimension and optimize the intensity profile of the beam profile in the direction of the long axis and the intensity profile of the beam profile in the direction of the short axis largely separately from one another. As a result, the novel device enables a defined laser illumination with an aspect ratio (the ratio of the extent of the beam profile in the direction of the long axis to the extent of the beam profile in the direction of the short axis) of more than 1000, for example.

The exit aperture of the beam transformer is the light-transmissive opening at the output of the beam transformer, through which the expanded laser beam can emerge in order to be fed to the homogenizer. In some exemplary embodiments, the exit aperture in the direction of the short axis may have an opening of approximately 1 mm, more generally an effective opening, in relation to the short axis, ranging between 0.5 mm and 10 mm. The second group of optical elements is able to image this exit aperture into the work plane in reducing fashion, and able to generate a laser line with a very small line width and a top hat intensity profile in the direction of the short axis. However, such reducing short axis imaging requires a relatively long path length along the optical axis. The first group of optical elements generates an intermediate image downstream of the homogenizer (as seen along the optical axis) and images this intermediate image into the work plane. In preferred exemplary embodiments, the first group of optical elements contains an imaging homogenizer, which generates the long axis beam profile in a defined plane along the optical axis. This plane acts as intermediate image plane. The long axis beam profile generated in the intermediate image plane is imaged into the work plane with the aid of further optical elements of the first group. In some exemplary embodiments, the homogenizer may contain one or more microlens arrays along the optical axis, and the intermediate image results from the overlay of the multi-lens aperture of the first microlens array. Expressed more generally, the first group of optical elements, with the aid of the homogenizer, generates an intermediate image of the long axis beam profile on the output side of the homogenizer and images this intermediate image into the work plane with the aid of further optical elements of the first group. This (further) imaging makes it possible to lengthen the relatively small extent of the long axis imaging in comparison with the short axis imaging to such an extent that both image representations coincide in the work plane. As a result, the novel device efficiently enables a large aspect ratio.

Therefore, the device according to embodiments of the present invention can realize an advantageous top hat intensity profile in the direction of the short axis by way of reducing a stop, the opening diameter of which in relation to the short axis may be >1 mm. Such a stop is cost-effectively producible from a manufacturing point of view. In order nevertheless to obtain a small line width of 10 μm, for example, and moreover also to keep the homogenizer cost-effective from a manufacturing point of view, it is advantageous to bridge the path length by way of multiple imaging in the direction of the long axis. The novel device enables this on account of the imaging of the intermediate image.

Moreover, the intermediate image plane can be used very advantageously for the placement of comb stops in order to optionally obtain a segmentation of the beam profile in the direction of the long axis. Where necessary, this makes it possible to very easily design the novel device so that a multiplicity of separate illumination spots are generated along the long axis. The structure of the novel device therefore offers variability in the direction of the short axis (variation of the line width with the aid of the exit aperture of the beam transformer) and in the direction of the long axis (segmentation of the laser line by way of suitable stops). The aforementioned object is achieved in a simple and cost-effective manner.

In a preferred configuration, the first group of optical elements further contains a first mask which is arranged in the region of the intermediate image.

In some exemplary embodiments, the first mask may be a comb-like stop with a multiplicity of apertures arranged next to one another, for example with a number of equidistantly arranged apertures. In further exemplary embodiments, the mask may contain a mirror coated on a segment-based basis with alternating highly reflective and antireflective layers. The apertures or the alternating layers may advantageously segment the beam profile in the direction of the long axis into separate illumination spots. In principle, the first mask may have a freely chosen distribution of light-transmissive or reflective and light-opaque or non-reflective regions. In this configuration, the novel device makes advantageous use of the variable basic concept by virtue of implementing a cost-effective segmentation of the beam profile in the direction of the long axis. The configuration is particularly advantageous for an LLO application for μLEDs that should be separated, or for laser induced forward transfer (LIFT), which is to say the transfer of already separated μLEDs to a future display.

In a further configuration, the first mask is designed as a replaceable part.

In this configuration, the user of the novel device may optionally place the first mask in the region of the intermediate image at the output of the homogenizer or remove said first mask from there. In some exemplary embodiments, the first mask may be held on a carrier body which may optionally be moved into or out of the beam path of the optical arrangement. In these exemplary embodiments, the first mask may be held in translational and/or rotational fashion and consequently be optionally pushed and/or pivoted into the beam path. The configuration increases the field of the use of the novel device.

In a further configuration, the second group of optical elements contains at least one second mask.

In this configuration, the novel device has a mask with which a desired intensity profile of the beam profile can be obtained in the direction of the short axis in simple and efficient fashion. In some exemplary embodiments, a top hat profile in the direction of the short axis is implemented with the aid of the second mask. Preferably, the aperture of the second mask is >1 mm as this allows a cost-effective implementation.

In a further configuration, the at least one second mask is arranged in the region of the beam transformer.

The placement of the second mask in the region of the beam transformer allows an efficient implementation of a desired intensity profile, in particular a top hat profile with steep slopes, in the direction of the short axis.

In a further configuration, the second group of optical elements generates a further intermediate image, the at least one second mask being arranged in the region of the further intermediate image. Preferably, the further intermediate image is an intermediate image of the beam transformer.

This configuration offers an advantageous and variable alternative, especially if the installation space in the region of the beam transformer is limited.

In a further configuration, the at least one second mask is designed as a replaceable part.

In this configuration, the user of the novel device can optionally place the second mask in the beam path or remove said second mask from the beam path. In some exemplary embodiments, the second mask may be held on a carrier body which may optionally be moved into or out of the beam path of the optical arrangement. The second mask may be held in translational and/or rotational fashion and consequently be optionally pushed and/or pivoted into the beam path. The configuration increases the field of the use of the novel device by virtue of enabling a fast and individual adaptation of the beam profile in the direction of the short axis.

In a further configuration, the imaging optical unit contains a folding optical unit having at least one mirror element, preferably having at least two mirror elements which implement multiple folding.

In this configuration, the imaging optical unit may in particular contain one or more cylindrical mirrors which implement multiple folding of the beam path in the direction of the long axis. This configuration enables a compact realization of the novel device while maintaining the above-described advantages.

In a further configuration, the second group of optical elements contains a projection lens arranged along the optical axis and closest to the work plane, the folding optical unit being arranged along the optical axis and between the homogenizer and the projection lens.

In this configuration, the optical elements of the first group are in a certain sense seated between the optical elements of the second group along the optical axis. This arrangement also contributes to a compact realization. It moreover enables a high beam quality in the direction of the short axis.

In a further configuration, the beam profile has a top hat-shaped intensity profile across the short axis beam width.

A top hat-shaped intensity profile is particularly advantageous for releasing μLEDs and other discrete component parts.

It is understood that the aforementioned features and the features yet to be explained below are usable not only in the respectively specified combination but also in other combinations or on their own, without departing from the scope of the present invention.

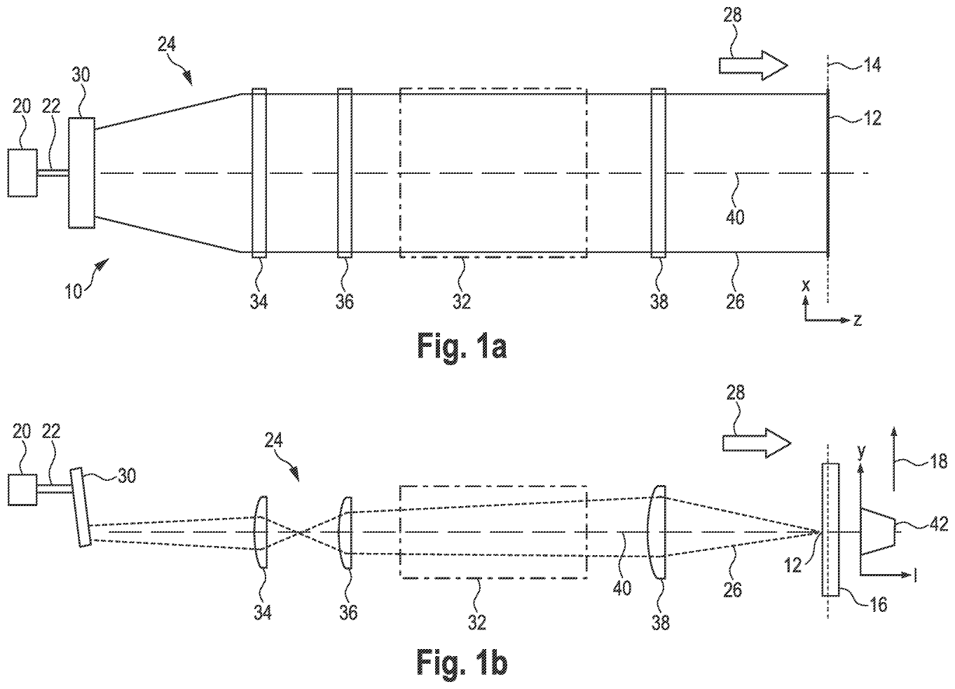

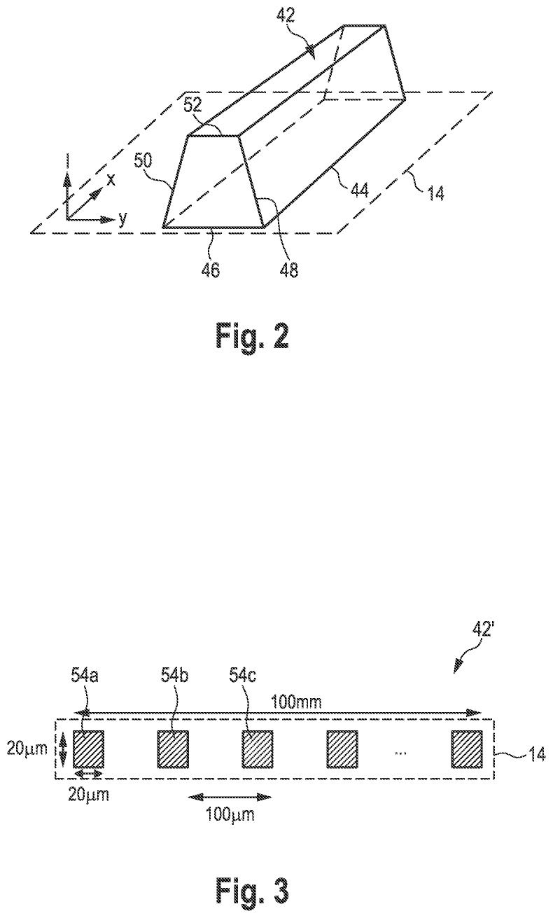

An exemplary embodiment of the novel device, in the entirety thereof, is denoted by reference sign 10 in FIGS. 1a and 1b. In this case, the device 10 generates a laser line 12 in the region of a work plane 14, in order to machine a workpiece 16 placed in the region of the work plane 14. In this case, the laser line 12 extends in the direction of an x-axis and the line width is considered here to be in the direction of a y-axis. Accordingly, the x-axis hereinafter denotes the long axis and the y-axis denotes the short axis of the beam profile formed on the work plane 14 (cf. FIG. 2).

In some exemplary embodiments, the workpiece 16 may contain a film layer with OLEDs which are arranged on a glass plate and which are intended to be detached from the glass plate with the aid of the laser line 12. To machine the workpiece 16, the laser line 12 can be moved relative to the workpiece 16 in the direction of the arrow 18.

The device 10 comprises a laser light source 20 which may be a solid state laser, for example, which generates laser light in the infrared range or in the UV range. By way of example, the laser light source 20 may contain a Nd:YAG laser with a wavelength of the order of 1030 nm. In further examples, the laser light source 20 may contain diode lasers, excimer lasers or solid state lasers, which respectively generate laser light with wavelengths between 150 nm and 360 nm, 500 nm and 530 nm, or 900 nm to 1070 nm.

The laser light source 20 generates a raw laser beam 22, which for example can be input-coupled into an optical arrangement 24 via an optical fibre. The raw laser beam 22 is reshaped into an illumination beam 26, which defines a beam direction 28, by means of the optical arrangement 24. The beam direction 28 intersects the work plane 14.

The optical arrangement 24 contains a beam transformer 30, which expands the raw laser beam 22 in the x-direction (corresponding to the long axis). In preferred exemplary embodiments, the beam transformer 30 may be realized like the beam transformer which is described in detail in WO 2018/019374 A1 cited at the outset. Therefore, WO 2018/019374 A1 is incorporated here by reference in relation to the beam transformer and the homogenizer described hereinafter.

In particular, the beam transformer 30 may contain a transparent, monolithic, planar element having a front side and a back side, which are substantially parallel to one another. The planar element may be arranged at an acute angle in relation to the raw laser beam 22, as indicated in FIG. 1b. The front side and the back side may each have a reflective coating such that the raw laser beam 22, which is input-coupled into the planar element obliquely at the front side, experiences multiple reflections within the planar element before it emerges, expanded in the direction of the x-axis, at the back side of the planar element. In other exemplary embodiments, the beam transformer may be realized as a stop or with the aid of a stop.

The optical arrangement 24 contains a long axis optical unit 32, which is only schematically indicated here and which shapes the expanded raw laser beam in the direction of the long axis and images the latter onto the work plane 14. In particular, the long axis optical unit 32 may contain one or more microlens arrays (not depicted here) and one or more lenses with an optical refractive power predominantly in the direction of the long axis. The microlens arrays and the one or more lenses can be in the form of cylindrical lenses which extend in the y-direction with their cylinder axis and which form an imaging homogenizer which homogenizes the raw laser beam 22 in the direction of the long axis in order to obtain a defined, typically top hat-shaped intensity profile in the direction of the long axis.

The optical arrangement 24 further contains a multiplicity of optical elements 34, 36, 38 which shape the expanded raw laser beam in the direction of the short axis and focus the latter onto the work plane 14. The optical elements 34, 36, 38 are arranged along an optical axis 40 and in this case contain a first lens 34 and a second lens 36, which together form a telescope arrangement. In this case, the optical element 38 is an objective lens with one or more lens elements, which focuses the illumination beam 26 in the direction of the short axis onto the work plane 14.

The optical arrangement 24, in the entirety thereof, is configured to generate the illumination beam 26 with a defined beam profile 42 in the region of the work plane 14. FIG. 2 shows an idealized representation of such a beam profile 42. The beam profile 42 describes the intensity I of the laser radiation on the work plane 14 depending on the respective positions along the x-axis and the y-axis. As indicated, the beam profile 42 has a long axis 44 with a long axis beam width in the x-direction and a short axis 46 with a short axis beam width in the y-direction. The short axis beam width 46 may be described for example as a full width at half maximum (FWHM) or as a width between the 90% intensity values (full width at 90% maximum, FW@90%). In this case, the beam profile 42 has a top hat profile in the direction of the short axis, with a first slope 48, a second slope 50 and a largely flat plateau 52 between the first slope 48 and the second slope 50. In principle, the beam profile 42 may have a different intensity profile, for example a Gaussian intensity profile, especially across the short axis 46.

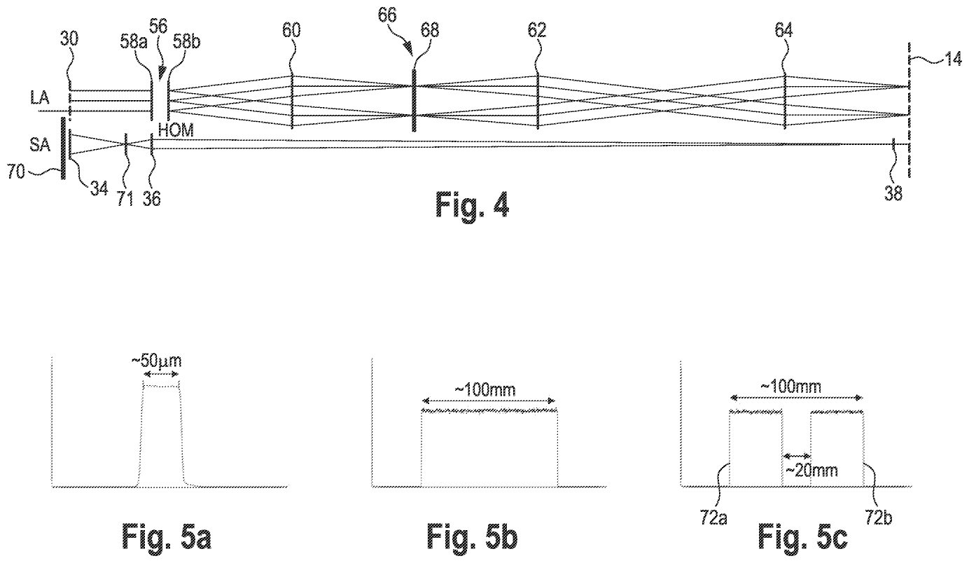

A beam profile 42 as represented in idealized fashion in FIG. 2 is desirable for some applications, for example detaching a relatively large OLED film from a carrier plate. By contrast, for other applications, it may be desirable to segment the beam profile 42 into a multiplicity of mutually spaced apart illumination spots 54a, 54b, 54c . . . . FIG. 3 shows such a segmented beam profile 42′ in a schematic plan view of the work plane 14 from above. In a preferred exemplary embodiment, the optical arrangement can generate a beam profile 42′ in which illumination spots 54a, 54b, 54c . . . are distributed equidistantly in the direction of the long axis. In this case, the long axis preferably extends over a distance of the order of 100 mm. In this case, the illumination spots 54a, 54b, 54c . . . each advantageously have a substantially rectangular footprint with dimensions of 20 μm×20 μm for example, and may be spaced apart from one another by 100 μm, for example. Preferably, the illumination spots 54a, 54b, 54c . . . each have a top hat profile in the direction of the short axis in this case. Such a segmented beam profile 42′ is advantageous for an LLO or LIFT application, in which a multiplicity of μLEDs should be detached from a carrier plate. The novel device 10 easily and efficiently enables such a desirable beam profile 42 in a few exemplary embodiments, as explained hereinafter with additional reference to FIGS. 4 to 7. Here, the same reference signs denote the same elements as previously.

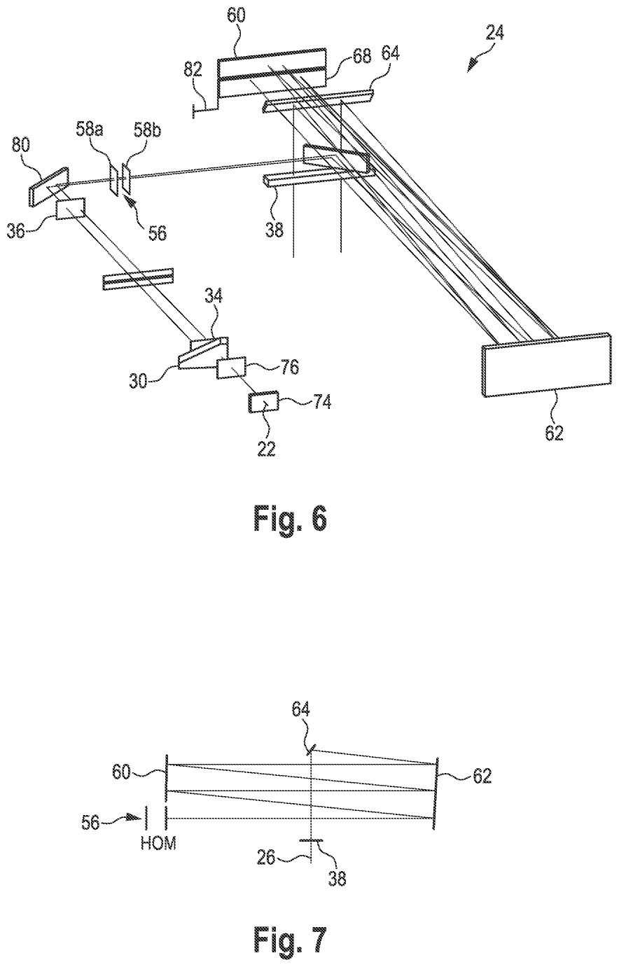

FIG. 4 shows the long axis optical unit 32 from FIGS. 1a and 1b with further details. The longitudinal axis optical unit 32 contains a homogenizer 56 which, in some exemplary embodiments, may contain a first microlens array 58a and a second microlens array 58b, which are arranged at a defined distance from one another along the optical axis. In this case, a first optical element 60, a second optical element 62 and a third optical element 64 are arranged over the further course of the beam path. In some exemplary embodiments, one or more of the elements 60, 62, 64 may be Fourier lenses. The elements 60, 62, 64 can be mirror elements, in particular cylindrical mirrors, in other exemplary embodiments, as explained hereinafter with reference to FIGS. 6 and 7.

In this case, the homogenizer 56 and the optical elements 60, 62, 64 form a first group of optical elements and shape the expanded raw laser beam in the direction of the long axis. By contrast, the optical elements 34, 36, 38 form a second group of optical elements which shapes the expanded raw laser beam in the direction of the short axis. As already indicated above, the optical element 60 in this case generates an intermediate image 66 of the long axis beam profile. The intermediate image 66 is imaged onto the work plane 14 with the aid of the optical elements 62, 64. Advantageously, in this case a (first) mask 68 may be arranged in the region of the intermediate image 66. In particular, the mask 68 can be a comb-like stop with a multiplicity of apertures arranged next to one another. The use of such a mask 68 allows simple and efficient segmentation of the beam profile 42′ (FIG. 3) in the direction of the long axis, in order to obtain mutually spaced apart illumination spots 54a, 54b, 54c . . . in accordance with FIG. 3.

Alternatively or in addition, a further mask 70 may in this case be arranged in the region of the beam transformer 30 and/or in the region of an intermediate image 71 of the beam transformer 30. The further mask 70 may have an aperture of >1 mm in relation to the short axis beam path with the optical elements 34, 36, 38. With the aid of the mask 70, it is possible to easily and efficiently obtain a top hat intensity profile in the direction of the short axis, with very steep slopes and a largely flat plateau. In this case, a long path length in the short axis beam path enables advantageously reducing imaging of the aperture onto the work plane 14, in order to obtain the dimension of the illumination spots 54a, 54b, 54c . . . of 20 μm in the direction of the short axis, which is indicated in FIG. 3 in exemplary fashion.

By way of example, FIG. 5a shows an intensity profile of a beam profile 42, 42′ in relation to the short axis, as may be obtained with the aid of the aforementioned mask 70. FIG. 5b shows an intensity profile of the beam profile 42 in relation to the long axis without the mask 68. FIG. 5c shows an intensity profile which has been segmented in the direction of the long axis using the aforementioned mask 68, with two mutually spaced apart line portions 72a, 72b. In order to obtain the intensity profile according to FIG. 5c with the mutually spaced apart line portions 72a, 72b, the mask 68 may have two mutually spaced apart apertures in the region of the intermediate image 66. The beam profile 42 can be segmented differently using a different mask 68, for example in the manner illustrated in FIG. 3.

FIG. 6 illustrates the optical arrangement 24 in one exemplary embodiment with further details. In addition to the aforementioned optical elements 34, 36, 38 of the short axis optical unit, each embodied as cylindrical lenses in this case, and the optical elements 60, 62, 64 of the long axis optical unit, each embodied as cylindrical mirrors in this case, the optical arrangement 24 in this case also comprises two further lenses 74, 76 in a telescope arrangement. The lenses 74, 76 focus the raw laser beam onto the entrance aperture of the beam transformer 30. The lenses 34, 36, which together form a (further) telescope, are arranged at the output of the beam transformer 30. In some exemplary embodiments, an optional spatial filter 78 may be arranged between the lenses 34, 36, for example in order to reduce possible diffraction artefacts. In this case, reference sign 80 denotes an optional deflection mirror which deflects the expanded raw beam to the homogenizer 56. The deflection mirror 80 advantageously contributes to enabling a compact structure of the optical arrangement 24. Downstream of the homogenizer 56, which may also contain two microlens arrays 58a, 58b in this case, the homogenized laser beam is guided to the mirrors 60, 62 with the aid of a further deflection mirror (concealed in this case). In this case, the mirrors 60, 62 reflect the laser beam multiple times, as illustrated in simplified fashion in FIG. 7, and in the process generate an intermediate image in the region of the mask 68. The masked intermediate image is guided to the projection lens 38 with the aid of the mirrors 60, 62, 64. The projection optical unit 38 focuses the expanded laser beam onto the work plane as illumination beam 26 and there generates the laser line 12 or—depending on the mask 68—a multiplicity of illumination spots which may be distributed in the direction of the long axis. In this case, a carrier is indicated at reference sign 82, and it can be used to move the mask 66 into or out of the beam path, depending on the desired application

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for generating a defined laser illumination on a work plane, the device comprising:
a laser light source configured to generate a raw laser beam; and
an optical arrangement configured to receive the raw laser beam and shape the raw laser beam along an optical axis into an illumination beam, the illumination beam defining a beam direction that intersects the work plane, wherein the illumination beam, in a region of the work plane, has a beam profile with a long axis beam width along a long axis and a short axis beam width along a short axis, both the long axis and the short axis being perpendicular to the beam direction, wherein the optical arrangement comprises:
a beam transformer with an exit aperture,
a first group of optical elements for beam shaping in the direction of the long axis, and
a second group of optical elements for beam shaping in the direction of the short axis,
wherein the beam transformer is configured to expand the raw laser beam in the direction of the long axis in order to generate an expanded raw laser beam, the first group of optical elements comprises a homogenizer configured to homogenize the expanded raw laser beam in the direction of the long axis, and the second group of optical elements comprises at least one lens configured to image the exit aperture of the beam transformer into the work plane, wherein the first group of optical elements generates an intermediate image downstream of the homogenizer,
the device further comprising an imaging optical unit configured to image the intermediate image into the work plane.

2. The device according to claim 1, wherein the first group of optical elements further comprises a first mask arranged in the region of the intermediate image.

3. The device according to claim 2, characterized wherein the first mask is designed as a replaceable part.

4. The device according to claim 2, wherein the first mask is a comb-like stop with a multiplicity of apertures arranged next to one another, the multiplicity of apertures generating separate illumination spots in the region of the work plane.

5. The device according to claim 1, wherein the second group of optical elements comprises at least one second mask.

6. The device according to claim 5, wherein the at least one second mask is arranged in the region of the beam transformer.

7. The device according to claim 5, wherein the second group of optical elements generates a further intermediate image, the at least one second mask being arranged in the region of the further intermediate image.

8. The device according to claim 5, wherein the at least one second mask is designed as a replaceable part.

9. The device according to claim 1, wherein the imaging optical unit comprises a folding optical unit having at least one mirror element.

10. The device according to claim 9, wherein the second group of optical elements comprises a projection lens arranged along the optical axis and closest to the work plane, the folding optical unit being arranged along the optical axis and between the homogenizer and the projection lens.

11. The device according to claim 1, wherein the beam profile has a top hat-shaped intensity profile across the short axis beam width.
